(19) United States
(12) Patent Application Publication
(10) Pub. No.: US 2003/0073023 A1
(43) Pub. Date: Apr. 17, 2003

(54) Electrophotographic carrier core ferrite powder

(76) Inventors: Lars Hultman, Viken (SE); Rose-Marie Yttergren, Helsingborg (SE); Fredrik Eklund, Helsingborg (SE); Nils Jonsson, Angelholm (SE)

Correspondence Address: BENTON S. DUFFETT, JR., BURNS, DOANE, SWECKER & MATHIS, L.L.P., P.O. Box 1404, Alexandria, VA, 22313-1404, US

(21) Appl. No.: 10/050,159

(22) Filed: Jan. 18, 2002

(30) Foreign Application Priority Data
Sep. 28, 2001 (SE) 0103264-8

(51) Int. Cl. G03G 9/113

(52) U.S. Cl. 430/111.31; 430/137.13

(57) ABSTRACT

The invention concerns a new carrier core material having high voltage breakdown. The new material comprises a particulate ferrite base material having a substantially spherical particle shape, wherein the powder particles are coated with an inorganic, electrically insulating coating having a resistivity higher than that of the ferrite base material.

### FIELD OF THE INVENTION

This invention relates to particulate ferrite materials useful as a carrier core component in electrophotographic developers, in particular two-component developers comprising the carrier component together with a toner component.

### BACKGROUND OF THE INVENTION

In electrophotography, the electrostatic image formed on the photoconductor is developed by the magnetic brush method using either the so called “one-component” developer or “two-component” developer. Usually, the two-component developer system comprises a mixture of relatively fine particles of a toner and relatively coarse particles of a carrier. The toner particles are held on the carrier particles by the electrostatic forces of opposite polarities which are generated by friction of the particles. When the developer comes into contact with an electrostatic latent image formed on the photosensitive plate, the toner particles are attracted by the image and thus make the latter visible. The thus developed image is then transferred onto a recording medium, such as a paper sheet. In the process, therefore, the toner particles should be charged with an accurately controlled amount of static electricity so that they are preferentially attracted to the electrostatically imaged area of the photosensitive plate.

This, in turn, means that the carrier which is used in combination with the toner must have an appropriate triboelectric property which enables it to electrostatically hold the toner particles and to transfer the held toner particles to the electrostatic latent image on the photosensitive plate when contacted. Additionally the carrier particles should have a sufficient mechanical strength to protect the carrier particles from breaking or cracking. These particles should also exhibit a good fluidity, be uniform in their electric and magnetic properties and be stable with respect to changes in the environmental conditions, such as humidity. The carrier particles should have a sufficient durability to ensure an acceptable lifetime.

In the most recent printing technology, which permits improved quality and speed, the distance between magnetic brush and photoreceptor is smaller and the currents during printing are higher, a consequence of which is that the carrier core itself must be able to carry some of the amount of current in the copying process. More specifically a higher voltage breakdown of the carrier core itself is needed. Preferably the high voltage breakdown should not be accompanied by a higher resistivity, but rather with a medium high resistivity.

The carrier core materials normally used when high voltage breakage is required are selected from ferrites. These compounds have the chemical formula Fe₂MO₄ wherein M can be Mn, Fe, Co, Ni, Cu, Zn, Cd, Mg. In order to meet different requirements depending on the specific type of copiers and printers used, i.a. the chemical composition of the ferrite has to be changed. A problem is that, in order to obtain ferrite powders having optimal properties, it is often necessary to manipulate the chemistry of these ferrite base powders so as to include different types of oxides of heavy metals. Such metals should, however, to the outmost possible extent be avoided as they are detrimental to the environment. Thus there is an increasing demand of a carrier core materials which do not pollute the environment and which can be easily and cost effectively modified to meet different needs.

### OBJECTS OF THE INVENTION

An object of the invention is to provide a new carrier core material having a high voltage breakdown value without being detrimental to the environment.

Another object is to provide a carrier core material, which can be produced cost effectively and meet different requirements regarding voltage breakdown and resistivity, such as high voltage breakdown and medium high resisitivity.

### SUMMARY OF THE INVENTION

In accordance with the present invention it has unexpectedly been found that such a material can be obtained when the individual particles of a ferrite base material are surrounded by an electrically insulating coating consisting of an inorganic material, such that the resistivity of the coated particles is higher than that of the ferrite base particles.

The invention also concerns a method for the preparation of such a new carrier core material.

### DETAILED DESCRIPTION OF THE INVENTION

Many ferrites have a comparatively high resistivity. However, as the critical feature of the present invention is the properties provided by the coating, comparatively inexpensive and simple ferrites having low resistivity and low voltage breakdown can be used as ferrite base material. Additionally, in order not to pollute the environment, these base ferrites should be essentially free from heavy metal oxides. In practice this means that only trace amount of heavy metals should be present in the ferrites used as starting or base material.

The magnetite (ferrite) base material could be obtained from natural or synthetic sources. Furthermore the base material preferably consists of at least 70%, most preferably at least 90% of magnetite. Minor amounts i.e. up to 30% by weight of other compounds, such as hematite, wustite, silicon, metallic iron, phosphorus, aluminia, titanium oxide, or inert inorganic or organic materials may be included in the magnetite (ferrite) base material.

Preferably the ferrite base material used according to the invention is magnetite, which is the simplest type of ferrites. The chemical formula of magnetite is Fe₃O₄ and, in the above formula, M is Fe.

The magnetite may be produced as described in the U.S. Pat. No. 4,663,262 which is hereby incorporated by reference. According to this patent the base magnetite is produced from natural magnetite by the following general procedure:

A magnetite powder is formed into agglomerates which are then calcined at a predetermined temperature under a specific-atmosphere. The calcined granules are suitably cracked or dispersed and then classified into a desired size distribution. Because the agglomerates are formed with a binder material which is effective for reducing the raw magnetite (Fe₃O₄) to wustite (FeO), the magnetite is partially converted to wustite during the calcination to give a product magnetite usually containing 15-20% of wustite. By controlling the temperature and the composition of the atmosphere during the cooling step after the calcinations magnetite powders containing less than 10%, preferably less than 3%, by weight of wustite may be obtained.

Furthermore, according to an embodiment of the invention, powders having particles with essentially spherical shape are preferred, as such powders have isotropic magnetic properties which are advantageous in many xerographic applications. The particle size of the base material used according to the present invention is normally between 15 and 200 μm. Typical examples of such substantially spherical magnetite base powders which may be used are magnetite powders of the CM series from Höganäs AB, Sweden.

The coating on the particles of the ferromagnetic powder of the present invention should preferably exhibit a number of properties. Thus, the coating should be insoluble in water and organic solvents. Furthermore, the coating should not have a negative influence on powder properties, such as apparent density and flow. Thus the apparent density of the new carrier core powder should preferably vary between about 1 and 4 g/cm³ and the flow between 20 and 25 s/50g. Furthermore, the inorganic insulating coating should completely cover the individual ferrite base particles. The coating should be coherent, homogenous and uniform and not contain organic material. An important feature of the coating is that it does not affect the magnetic properties of base powder and thus the magnetic properties of the insulated powder particles are essentially the same as those of the base powder. Typical values for magnetic properties of suitable base powders are for saturation, σs, 90-96 emu/g, for remenence, σr, <3 emu/g and for coercivity, H_{C}<30 Oe. Most importantly, the coating should impart high voltage breakdown as well as other properties to the carrier core materials required for modern xerographic applications.

According to the present invention the coating might be based on an inorganic compound such as an inorganic oxide, nitride or carbide. Typical examples of inorganic compounds manganese dioxide, boron trioxide tin oxide, silicon dioxide, vanadium oxide, titanium oxide, zirconium dioxide, molybdenum oxide, magnesium oxide, aluminium oxide and yttrium oxide. Any one of these materials or a mixture of two or more of them can be used. So far the best results have been obtained by a phosphate coating. The thickness of the coating is decided by the final properties of the coating. Normally a thickness in the range of from about 0.1 to about 5 μm is preferred.

The method of providing the coating is not critical. Thus the coating may be provided by using CVD technique or other commonly known and used techniques for powder coating.

According to the present invention the inorganic coating is preferably obtained by mixing the ferrite base powder with a coating solution. An example of a preferred coating solution is a solution of phosphorus acid, such as ortophosphorous acid, which is dissolved in water or an organic acid. The amount and concentration of the phosphorus acid is decided by the desired final properties of the insulated powder. Generally the amount of coating solution may range between 20 and 80 ml per kg magnetite powder.

According to the present invention insulated particles having very high voltage breakdown values, such as up to 1000 V or even higher may be obtained whereas values below about 500 V are less important for modern printing technology. The resistivity of the insulated particles preferably varies between about 10⁸ and 10¹⁰.

The insulated carrier core particles according to the present invention are subsequently coated with a thin resinous layer in order to produce a carrier material. This layer is needed e.g. in order to adjust the tribo and increase life. The amount of this organic or resinous layer is normally between about 1.5 to 6% by weight of the carrier core.

The invention is further illustrated by the following non limiting examples.

### EXAMPLE 1

The base material in the following example is CM 70, a spherical magnetite with a mean particle size of 70 μm, available from Höganäs AB, Sweden. A coating solution was obtained by dissolving various amounts of phosphorus acid in water. The coating solutions were thoroughly mixed just before they were added to the magnetite powders in order to avoid segregation. The coating solutions were added to the powder with a rate of 25 ml per kg powder for a period of 90 s. The obtained mixture was thoroughly mixed and the temperature was between 80 and 90° C. The solution was evaporated leaving the insulated particles as a residue. As a last step the dried powder was sieved in order to eliminated oversized particles and agglomerates.

The following results were obtained:

TABLE 1

| Coating | Amount of | | |
|---|---|---|---|
| solution | coating | | Voltage |
| % phosphoric | solution | Resistivity* | breakdown* |
| acid | (ml) | Ohmm | (V) |
| 30 | 25 | 8.7 * 10⁹ | 550 |
| 30 | 50 | 4.4 * 10⁹ | >1000 |
| 30 | 75 | 4.3 * 10⁹ | >1000 |
| 46 | 25 | 6.3 * 10⁹ | >1000 |
| 46 | 50 | 6.3 * 10⁹ | >1000 |
| 46 | 75 | 4.7 * 10⁹ | >1000 |
| —** | — | 7 * 10⁷ | 40 |

*The electrical resistance and the voltage breakdown of the carrier cores was measured using the C meter from PES Laboratory (Dr. R. Epping, Neufahrn).
**Uncoated reference, CM70. As can be seen from the results the inorganic coating increases the resistivity of the carrier core material.

### EXAMPLE 2

In this example a base magnetite powder CM 40 was used. This powder was subjected to an oxidation treatment as suggested in the U.S. Pat. No. 4,663,262. Part of the obtained oxidised powder (=Sample CM40A) was provided with an inorganic coating (=Sample CM40B) according to the present invention. As can be seen from the Table 2 below the resistivity is increased by the oxidation treatment. However the voltage breakdown is considerably lower than that of the coated powder according to the present invention.

TABLE 2

| | | Voltage breakdown* |
|---|---|---|
| Sample | Resistivity* ohmm | (V) |
| CM 40A | 2.2 * 10⁹ | 425 |
| CM 40B | 1.1 * 10¹⁰ | 700 |
| CM 40 | 7 * 10⁷ | 40 |

*The electrical resistance and the voltage breakdown of the carrier cores was measured using the C meter from PES Laboratory (Dr. R. Epping, Neufahrn).

As can be seen from the results in the above table the electrical properties are considerably improved by using an inorganic coating according to the present invention. Thus, the voltage breakdown can reach high values which are comparable to those of ferrites. An unexpected effect is that the high voltage breakdown properties do not necessary involve high resitivity of the carrier cores. High resistivity of the carrier cores is not desired as the amount of toner per carrier is decreased when the resistivity is increased. Additionally the improvements in the electrical properties do not affect other properties such as magnetic properties of the carrier cores.

1. A new electrophotographic carrier core powder having a voltage breakdown of at least 500 V and essentially consisting of a particulate ferrite base material, the particles of which are surrounded by an electrically insulating coating consisting of an inorganic material, such that the resistivity of the coated particles is higher than that of the ferrite base particles.

2. The carrier core material according to claim 1 wherein the ferrite base material is essentially free from heavy metals.

3. The carrier core material according to any one of the claims 1 or 2 wherein the particles of the ferrite base material are essentially spherical.

4. The carrier core material according to any one of the claims 1 or 2 wherein the magnetite base powder particles include at least 70%, preferably at least 90% magnetite.

5. The carrier core material according to any one of the claims 1-4 wherein the magnetite base powder particles include hematite, wustite, silicon, metallic iron, phosphorus, aluminia, titanium oxide, or inert inorganic or organic materials.

6. The carrier core material according to any one of the claims 1-5 wherein the inorganic coating is coherent, homogenous and uniform and does not contain organic material.

7. The carrier core material according to any one of the claims 1-6, wherein the insulating coating essentially consists of phosphate.

8. The carrier core material according to any one of the claims 1-7 wherein the inorganic coating also includes elements selected from the group consisting of Ti, Zr, Mg and Al.

9. The carrier core material according to any one of the claims 1-8, wherein the thickness of the insulating coating is at least about between 0.1 and 5 μm.

10. The carrier core material according to any one of the claims 1-9, wherein the size of the insulated particles ranges from about 15 to about 200 μm.

11. The carrier core material according to any one of the claims 1-10 having a voltage breakdown of at least 500V, preferably at least 700 V.

12. The carrier core material according to any one of the claims 1-11 having a resistivity of between about 10⁸ and 10¹⁰ ohmm.

13. A method of preparing a carrier core powder comprising the steps of preparing a coating solution by dissolving phosphorus acid in water, adding the obtained solution to a ferrite base powder while mixing, evaporating the solution and drying the obtained powder containing the insulated powder particles.

14. The carrier material consisting of a carrier core material according to any one of the claims 1-12 wherein the insulated particles are provided with a second organic coating applied on the inorganic coating.
